(19) United States
(12) Patent Application Publication
(10) Pub. No.: US 2006/0044218 A1
(43) Pub. Date: Mar. 2, 2006

(54) Display device

(75) Inventors: Cheng-Hong Tsai, Lujhou City (TW); Yu-Chih Liu, Linyuan Township (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: BENQ Corporation

(21) Appl. No.: 11/213,583

(22) Filed: Aug. 26, 2005

(30) Foreign Application Priority Data
Aug. 27, 2004 (TW) 93125854

(51) Int. Cl. G09G 5/00

(52) U.S. Cl. 345/3.1

(57) ABSTRACT

A display device including a graphic unit, a memory, a video enhancing unit and a display monitor is provided. The graphic unit is for outputting a first video. The memory stores a number of predetermined parameter. The video enhancing unit, which receives the first video and selects a enhancing control parameter from a number of predetermined parameters, adjusts the first video, then outputs a second video. Lastly, the display monitor displays an image according to second video.

This application claims the benefit of Taiwan application Serial No. 93125854, filed Aug. 27, 2004, the subject matter of which is incorporated herein by reference.

### BACKGROUND OF THE INVENTION

1. Field of the Invention

The invention relates in general to a display device, and more particularly to a display device capable of enhancing the display effect of an image.

2. Description of the Related Art

FIG. 1 is a block diagram of a conventional display device. A display device 100, such as a notebook computer or a personal computer for instance, includes a host 110 and a display panel 150. The host 110 includes a CPU 112, a north bridge 114, a south bridge 116, a keyboard controller 118, a memory 120 and a graphic unit 122. The memory 120 can be an EEPROM for instance. The graphic unit 122 outputs a video V to the display panel 150 to display an image. The video V can be an LVDS video for instance.

A conventional notebook computer achieves the object of enhancing the display effect by adjusting the graphic unit 122 to enhance the outputted video V. The enhanced items of display effect such as the edge enhancement enables a complete and clear frame of image to be displayed. The display effect can also be achieved by adjusting the Gamma curve to change the tone and contrast of the video V.

However, the colors of the image would be affected if the enhancement of display effect is achieved by adjusting the Gamma curve alone. For example, originally, the Gamma curve is adjusted for the video V to skew to red color so that the color of the skin looks pinkish. By doing so, other color of the image also skew to red color, causing the colors of the image unnatural. The graphic unit has only a few adjusting methods to enhance the display effect, so the quality of image display can not be further improved.

### SUMMARY OF THE INVENTION

It is therefore an object of the invention to provide a display device capable of further enhancing the display effect of an image.

According to the object of the invention, a display device including a graphic unit, a memory, a video enhancing unit and a display monitor is provided. The graphic unit is for outputting a first video. The memory stores a number of predetermined parameter. The video enhancing unit, which receives the first video and selects a enhancing control parameter from a number of predetermined parameters, adjusts the first video, then outputs a second video. Lastly, the display monitor displays an image according to second video.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a block diagram of a conventional display device;

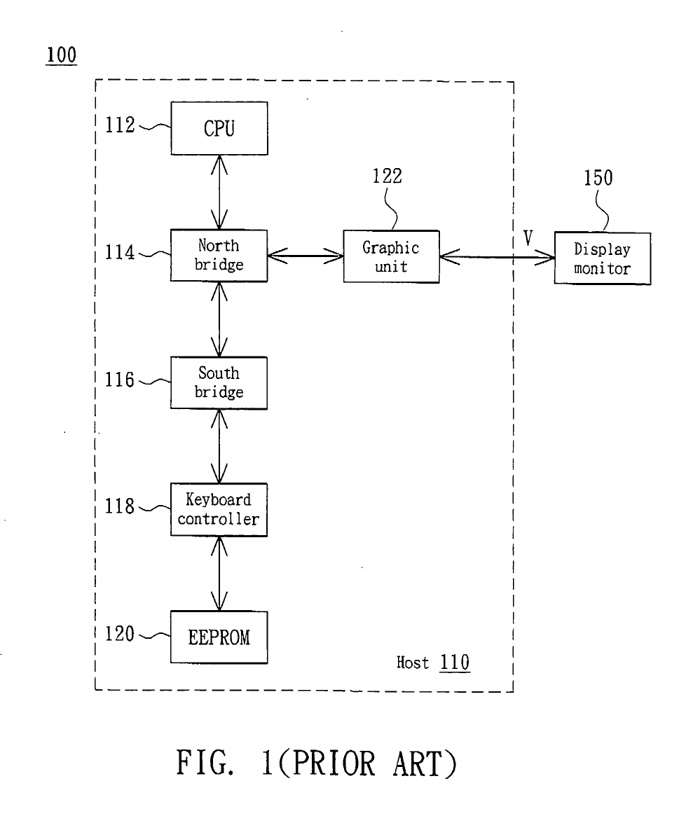

FIG. 2 is a diagram of a display device according to a preferred embodiment of the invention; and

FIG. 3 is a diagram of an image of a display device display.

### DETAILED DESCRIPTION OF THE INVENTION

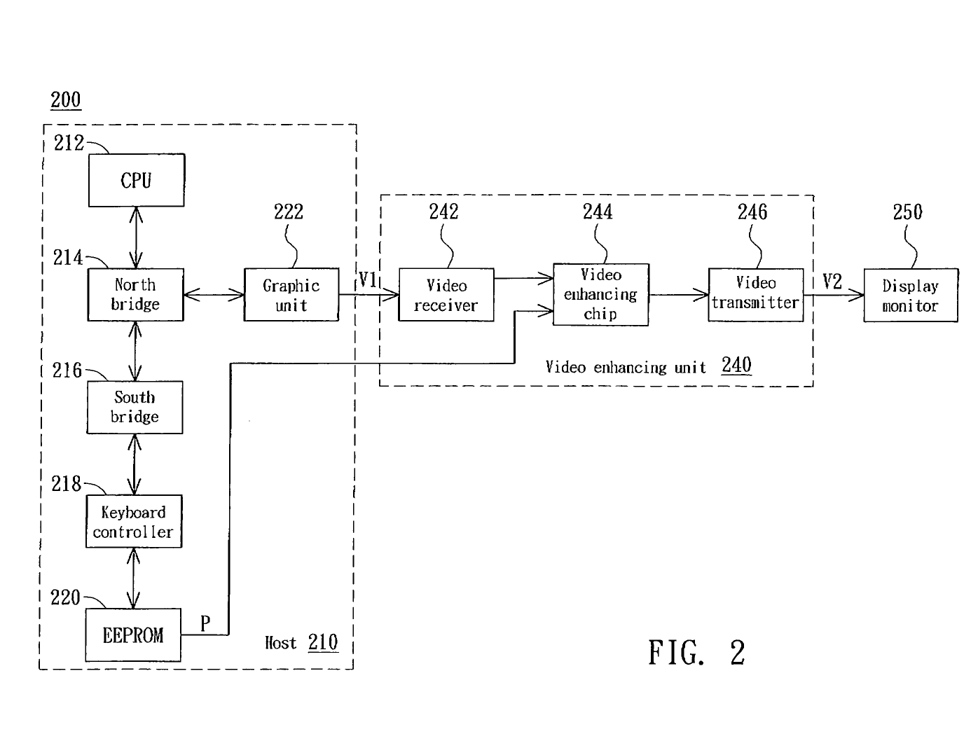

Referring to FIG. 2, a diagram of a display device according to a preferred embodiment of the invention is shown. A display device 200, such as a notebook computer or a personal computer for instance, includes a host 210, a video enhancing unit 240 and a display panel 250. The host 210 outputs a video V1. The quality of the video V1 is enhanced by the video enhancing unit 240 then displayed on the display panel 250.

The host 210 includes a CPU 212, a north bridge 214, a south bridge 216, a keyboard controller 218, a memory 220 and a graphic unit 222. The memory 220 can be an EEPROM for instance. The graphic unit 222 outputs a video V1 such as an LVDS video, a DVI video or a DSUB video for instance.

The video enhancing unit 240 receives the video V1 and an enhancing control parameter P, determines the desired video enhancing items according to the enhancing control parameter P, then adjusts the video V1 and outputs a video V2. The video enhancing unit 240 can provide several video enhancing items to enhance the video V1. The video enhancing items such as 3D color adjustment, edge enhancement, ACR white balance, FCT color tuning and contrast adjustment, gray level adjustment, brightness adjustment and sharpness adjustment and so forth.

The memory 220 stores a number of predetermined parameters respectively corresponding to various video enhancing items. The user can control via the keyboard, so that the keyboard controller 218 selects one or several predetermined parameters from the memory 220 to be outputted as the enhancing control parameter P. The video enhancing unit 240 receives the enhancing control parameter P the video V1 is adjusted accordingly to enhance the display effect. The present embodiment is exemplified by selecting two desired video enhancing items via the keyboard. However, the selection can be made via other man-machine interfaces. For example, the selection can be made on the monitor directly according to a program with a selection menu displayed on the monitor. The selection can also be made by setting one program to at least one predetermined parameter such that, when the program is executed, the corresponding predetermined parameter is automatically selected.

The video enhancing unit 240 includes a video receiver 242, a video enhancing chip 244 and a video transmitter 246. The video V1 can be an LVDS video, a DSUB video or a DVI video. The video receiver 242 converts the received video V1 into a first internal video of TTL format then outputs the first internal video accordingly. The video enhancing chip 244, after receiving first internal video, adjusts first internal video according to the enhancing control parameter P then outputs a second internal video. The second internal video can be a TTL format for instance. Then, the video transmitter 246 outputs a video V2 to drive the display monitor 250 according to the second internal video. The video V2 can be an LVDS video, a DSUB video, a DVI video, a composite video, or an S video.

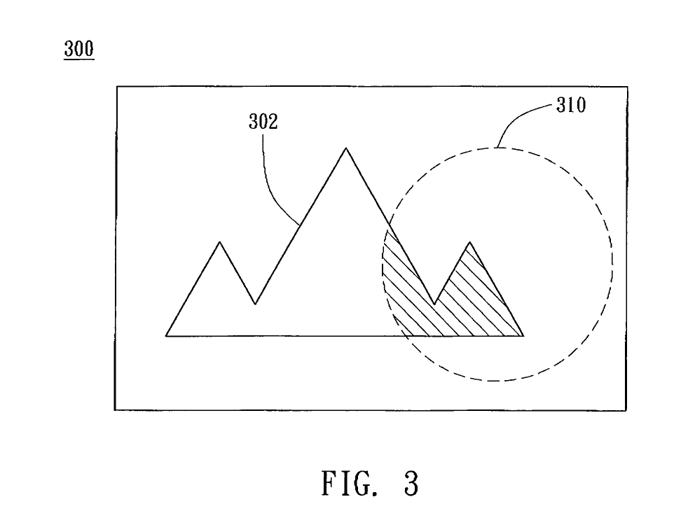

Apart from adjusting the video V1 of entire image, the present embodiment can adjust only a particular region of the image or performs different adjustments on various regions of the image, for example a signal window region. Referring to FIG. 3, a diagram of an image is shown. An image 300 display a mountain 302. The image 300 includes a region 310, the video enhancing unit 240 adjusts only the region 310, and not any adjustment is made elsewhere. Therefore, the host 310 needs to transmit a region parameter marking the position of the region to the video enhancing unit 240, and transmit an enhancing control parameter P corresponding to the region, so that the video V1 is separated into sub-videos representing the region 310 and the other region. Video enhancing unit 240 then adjusts the sub-video representing the region 310 according to the enhancing control parameter P. Then, the video enhancing unit 240 integrates adjusted sub-videos as a video V2 for outputting. If there are various regions to be enhanced, various parameters can be used to correspond to respective regional enhancements.

Besides, if the video enhancing unit 240 needs to use various enhancing control parameters to enhance the effect of the regions other than the region 310, the host 310 needs to transmit another enhancing control parameter P′ to the video enhancing unit 240 for the regions outside the region 310 to be enhanced. Then, the video enhancing unit 240 integrates the adjusted sub-videos as a video V2.

The present embodiment uses a video enhancing chip to enhance video effect instead of adjusting the Gamma curve alone, therefore achieving a variety of video enhancing effect. The item of edge enhancement enables the frame to be clearly and completely displayed, even the hair would look three-dimensional. The ACR white balance is an adjustment according to the characteristics of the display monitor 250, so that a better white balance effect is achieved. The FCT color tuning is capable of adjusting 6 individual colors without affecting other colors or the white balance, so the color appears to be more brightly colored. The contrast and brightness adjustment enables the objects to be clearly seen even in evening or dark scenery. The 3D color item deals with the depth of field, so that the 3D depth of field is vividly presented such as the clouds and the sky.

The display device disclosed in above embodiments of the invention enhances the quality of the video without using CPU resources, therefore achieving better operation efficiency.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A display device, comprising:
a graphic unit for outputting a first video;
a memory, which stores a plurality of predetermined parameters, and outputs an enhancing control parameter selected from the plurality of predetermined parameter;
a video enhancing unit, which receives and adjusts the first video according to the enhancing control parameter for generating a second video; and
a display monitor, which displays an image according to the second video.

2. The display device according to claim 1, wherein the first video is a DSUB video, an LVDS video or a DVI video.

3. The display device according to claim 1, wherein the video enhancing unit comprises:
a video receiver, which receives the first video and outputs a first internal video;
a video enhancing chip, which receives and adjusts the internal video according to the enhancing control parameter, then outputs a second internal video; and
a video transmitter, which outputs the second video according to the second internal video.

4. The display device according to claim 3, wherein the first internal video and the second internal video are of TTL format.

5. The display device according to claim 1, wherein the enhancing control parameter includes a first sub-parameter and a second sub-parameter, the video enhancing unit further receives a region parameter so that the first video is divided into a first sub-video and a second sub-video, the video enhancing unit adjusts the first sub-video according to the first sub-parameter, adjusts the second sub-video according to the second sub-parameter, and integrates the first sub-video and the second sub-video into the second video.

6. The display device according to claim 1 further comprising a man-machine interface for selecting and generating the enhancing control parameter from the predetermined parameters.

7. The display device according to claim 1, wherein the display device uses a keyboard controller to select and generate the enhancing control parameter from the predetermined parameters.

8. The display device according to claim 1, the display device being a personal computer having an execution program, wherein the execution program corresponds to the enhancing control parameter and selects the enhancing control parameter from the predetermined parameters when the execution program is performed.

9. The display device according to claim 1, wherein the video enhancing unit adjusts the 3D color, the contrast, the gray level, the edge enhancement, the sharpness or the brightness of the first video according to the enhancing control parameter.

10. The display device according to claim 1, wherein the second video is an LVDS video, an S video, a composite video or a DSUB video.

11. A display device, comprising:
a graphic unit for outputting a first video;
a video enhancing unit, which receives the first video according to a region parameter so that the first video is divided into a first sub-video and a second sub-video, the video enhancing unit adjusts the first sub-video according to a first enhancing control parameter and adjusts the second sub-video according to a second enhancing control parameter, and the video enhancing unit integrates the first sub-video and the second sub-video into a second video; and
a display monitor, which displays an image according to the second video.

12. The display device according to claim 11, the display device being a personal computer having an execution program and a memory, wherein the memory stores a plurality of predetermined parameters, the execution program selects the first enhancing control parameter and the second enhancing control parameter from the plurality of predetermined parameter when the execution program is performed.

13. The display device according to claim 12, wherein the region parameter defines a window region on the image, and the program operates within the window region.

14. The display device according to claim 11, wherein the first video is a DSUB video, an LVDS video or a DVI video.

15. The display device according to claim 11, wherein the video enhancing unit comprises:
a video receiver, which receives the first video and outputs a first internal video;
a video enhancing chip, which receives the internal video and adjusts the internal video according to the enhancing control parameter, then outputs a second internal video; and
a video transmitter, which outputs the second video according to the second internal video.

16. The display device according to claim 15, wherein the first internal video and the second internal video are of TTL format.

17. The display device according to claim 11, wherein the second video is a DVI video, an LVDS video, an S video, a composite video or a DSUB video.
